(19) United States
(12) Patent Application Publication
(10) Pub. No.: US 2024/0371260 A1
(43) Pub. Date: Nov. 7, 2024

(54) Road Sentinel AI Pylon

(71) Applicant: William B. Yan, Ontario, CA (US)

(72) Inventor: William B. Yan, Ontario, CA (US)

(73) Assignee: Forge Core Inc., Ontario, CA (US)

(21) Appl. No.: 18/655,238

(22) Filed: May 4, 2024

Related U.S. Application Data
(60) Provisional application No. 63/464,009, filed on May 4, 2023.

(51) Int. Cl. G08G 1/01; G08G 1/04

(52) U.S. Cl. CPC G08G 1/0141; G08G 1/0108; G08G 1/0129; G08G 1/04

(57) ABSTRACT

Improvements in a road sentinel AI pylon that monitors the area around the pylon(s) to map out the area and movement within the area surround the pylon(s) for hazard detection and monitoring. Each pylon can be set up, moved, or relocated and in addition to the sensors include a display to aid drivers. The pylons create a meshed mobile advances personal security system that can provide awareness of road system to improve traffic with a traffic flow management system. The pylons can detect a road hazard using grid road extraction and detection, with wrong way driver detection. The system further includes a mobile advanced personal security system that helps with finding individuals that are lost or have dementia, it can also aid in helping individuals that may be non-responsive.

### CROSS-REFERENCE TO RELATED APPLICATIONS

This application claims the benefit of Provisional Application Ser. No. 63/464,009 filed May 4, 2023, the entire contents of which is hereby expressly incorporated by reference herein.

### PRIOR ART

U.S. Patent publication 2022/0380990 was published on Dec. 1, 2022, to Leon Senneth et al., and is titled Apparatus and Method for Controlling a Functional Road Object. This publication discloses a method, apparatus and computer program product are provided for controlling a functional road object. For example, at least one processor receives road sign attribute data indicating at least one attribute of a road sign and receives weather forecast data indicating a weather forecast of a location in which the road sign is disposed. The road sign includes at least one machinery for mitigating exposure to one or more weather conditions. The at least one processor identifies a state of visibility for the road sign using the road sign attribute data and the weather forecast data and generates a control signal for controlling the at least one machinery using the state of visibility. While this publication is for a road sign the road sign does not track moving objects on the road.

U.S. Patent publication 2022/0148421 was published on May 12, 2022, to Esther S. Massengill et al and is titled Instrumented Traffic Cones for 5G/6G networking. This publication discloses an instrumented traffic cone that provides visual demarcation of a passageway for vehicles or pedestrians, as well as a boundary around a facility such as a secure facility. Each instrumented traffic cone may be equipped with a sensor and a wireless communicator. The sensor may be a camera, an infrared detector, a lidar or radar or sonar or other sensor type. The wireless communicator may be configured for 5G or 6G communication and may enable each instrumented traffic cone to report its measurement data to peers or to a supervisor, and to receive instructions from the supervisor or other instrumented traffic cones. The instrumented traffic cones may employ an AI-developed algorithm to form a self-organized network and to assign responsibilities among the instrumented traffic cones. While the traffic cones can communicate with each other they do not provide a communication link to drivers in advanced of the driver interacting with the traffic cone area.

U.S. Patent publication 2022/0390249 was published on Dec. 8, 2022, to Liu Lingling et al., and is titled Method and apparatus for Generating Direction Identifying Model, Device, Medium, and Program Product. This publication discloses a method and apparatus for generating a direction identifying model, a device, a medium, and a program product are provided. The method includes: acquiring direction-targeted road test data corresponding to a target road, and a guide arrow sign and an accessible road-direction corresponding to the target road; and training a machine learning model by using the road test data and the guide arrow sign as an input of the direction identifying model, and using the accessible road-direction as an output of the direction identifying model, to obtain the direction identifying model. The publication does not disclose creating a virtual 3D environment of the surrounding road.

U.S. Patent publication 2021/0148719 was published on May 20, 2021, to XU Jingwei et al., and is titled Method and Apparatus for Estimating a Location of a Vehicle. This publication discloses a method, apparatus and computer program product are provided to estimate the location of a vehicle based at least in part upon two or more road signs that are depicted by one or more images captured by one or more image capture devices onboard the vehicle. By relying at least in part upon the two or more road signs, the location of the vehicle may be refined or otherwise estimated with enhanced accuracy, such as in instances in which there is an inability to maintain a line-of-sight with the satellites of a satellite positioning system or otherwise in instances in which the location estimated based upon reliance on satellite or radio signals is considered insufficient. While this publication estimates the location of a vehicle it does not disclose using the data to improve traffic flow.

What is needed is a fixed or transportable information road sign that can monitor vehicles and the environment in the surrounding area to improve awareness and accuracy of the present and past road and travel conditions. The road sentinel AI pylon disclosed in this document provides the solution as a unique smart city technology with two distinct capabilities that greatly increase the safety of individuals and our roadways.

### BACKGROUND OF THE INVENTION

Most drivers have limited advance notice about hazards and traffic unless they have access to an internet connection. Even the information from an internet connection has some delay. Traffic cones or signs have none or repeating information with no updates, they usually just direct traffic around a fixed or planned obstruction. Currently, regions with high population density suffer from congested highways plagued with little problems that create major traffic conditions, adding hours to an already exhausting commute. Self-driving technology is supposed to get us to an efficient future, however, there are still a lot of issues that customers rarely use it. According to some analysts, we are still decades away from full self-driving.

### SUMMARY OF THE INVENTION

It is an object of the road sentinel AI pylon to provide a meshed aware road system that enhances advance driver Assistance systems thereby enabling a safer and more predictable riding experience.

It is another object of the road sentinel AI pylon to include a mobile advances personal security system that can be activated to protect an individual as they leave their home. The system has many uses to improve the safety and effectiveness of our road systems.

It is another object of the road sentinel AI pylon to address current problems such as traffic flow, road hazards, emergency response times, object/trash clean up, potholes and other road surface issues, wrong-way driving, and the unpredictable inconsistency of self-driving vehicles of today. By combining roadside sensors with artificial intelligence and machine learning the system gives end-users real-time, precise road data which allows smart vehicles to navigate the streets with never-before-seen awareness and accuracy. This will increase the level of trust in self-driving technology which greatly increases the adoption rate of self-driving vehicles, speeding us to a highly efficient road system.

It is an object of the road sentinel AI pylon to aid in the transition to a fully self- driving future by enhancing the cars of today using a traffic flow management system that will control traffic when there is an emergency and divert cars to a specific lane by notifying users and/or with an LED light indicator which can be seen from individual or networked pylons. The system can also create paths for emergency vehicles in congested roadways, improving medical response times.

It is an object of the road sentinel AI pylon to also include a hazard detection and monitoring system that utilizes artificial intelligence to monitor objects on the road in real-time. This system utilizes machine learning and personnel to quickly detect and classify objects which will be shared throughout the roadside sensor infrastructure so that can generate the safest path around objects.

It is still another object of the road sentinel AI pylon to include wrong way driver detections that detects contraflow driving vehicles. None of these functionalities could be possible without the base technology that allows for the accurate positioning of vehicles on the road.

It is still another object of the road sentinel AI pylon to utilize a proprietary algorithm to map out the road from the pylons that extract, detect, and map out the section of the road, and over time develop a foundational baseline and an overtime baseline of the road features.

It is still another object of the road sentinel AI pylon to use a non-GPS geo-fencing technology that oversees and monitors the safety of an individual. The system uses the interaction of different objects and determines if an emergency event has occurred. Then activates an appropriate method of remediation for that event.

It is still another object of the road sentinel AI pylon to help individuals like the elderly when they fall and are not responsive. A preliminary call can be made causing an alert that can try to wake the elderly. Then a call can be made to a caregiver or a family member. If all these actions fail, then a call to the medical response unit like an ambulance could be activated. This is useful for anyone who is an outdoor enthusiast that wants to be overwatched during their excursion.

It is still another object of the road sentinel AI pylon to assist in locating an individual with dementia or who is lost. The system follows objects that wonder and determine their starting point and current location to quickly find individuals. This can also be used to track pets when they roam around the neighborhood. If an individual or a pet goes beyond the set location a notification can be sent to caregivers or pet owners.

Various objects, features, aspects, and advantages of the present invention will become more apparent from the following detailed description of preferred embodiments of the invention, along with the accompanying drawings in which like numerals represent like components.

### BRIEF DESCRIPTION OF DRAWINGS

FIG. 1 shows a Meshed Aware Road System (MARS).

FIG. 2 shows a Mobile Advanced Personal security (MAPS).

FIG. 3 shows a Traffic Flow Management System (TFMS).

FIG. 4 shows a flow chart of Wrong Way Driver Detection (WAVE).

FIG. 5 shows a block diagram of a pylon with the internal and external communication connections.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

### ITEM NUMBERS AND DESCRIPTION

| | |
|---|---|
| 18 pothole | 19 roadway |
| 20 fixed pylon | 21 mobile pylon |
| 22 sensor(s) | 23 solar panel |
| 30 roadway | 31 individual |
| 32 dog | 40 home |
| 41 post | 42 sign head |
| 50 sign | 51 |
| 60 pylon activated | 61 GPS location/link |
| 62 data entered/merged | 63 continuous updates |
| 64 map surrounding area | 65 anomalous condition |
| 66 type of anomaly | 67 determine action |
| 68 notification system | 69 notify drivers |
| 100 Pylon | 110 Intake sensor data |
| 111 Global data | 112 L3DE Data |
| 113 load base data information | 120 Data processing layer |
| 121 landscape & signage | 122 sidewalks |
| 123 Decimal degree | 124 Lanes & lane markings |
| 125 sub lanes | 126 center lanes |
| 127 render environment | 128 object tracking |
| 129 road characteristics | 130 Identify sensor data |
| 131 pedestrians & animals | 132 traffic cones |
| 133 vehicles | 134 Misc objects (debris) |
| 135 object learning | 140 local object tracking |
| 141 modem | 142 Mesh network (local) |
| 143 Mesh network (connected) | 144 mobile client |
| 150 cellular network | 151 tower(s) |
| 152 Forgo core data center | 153 LiDAR |

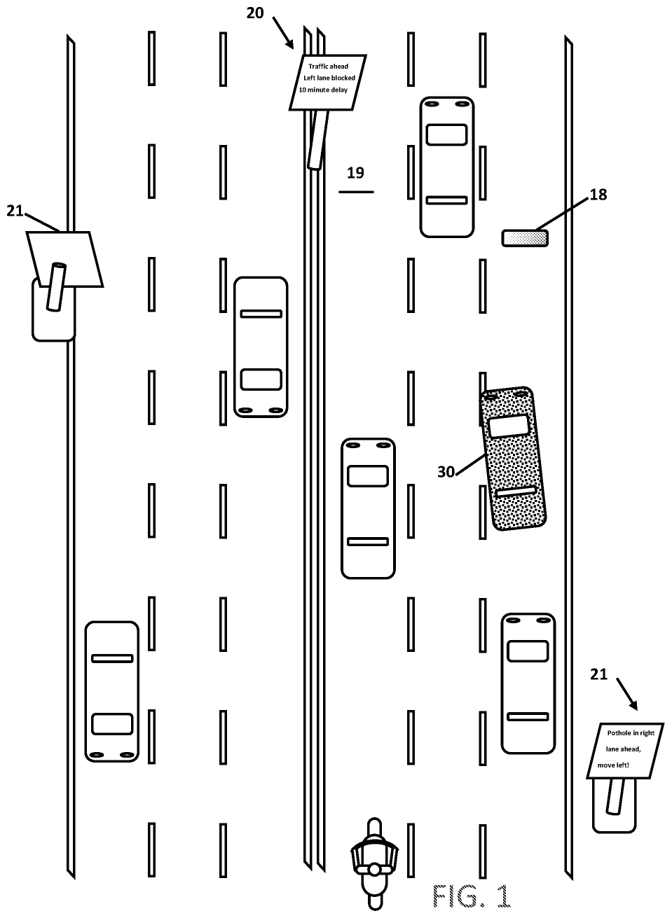

FIG. 1 shows a Meshed Aware Road System 20 (MARS) with a fixed pylon 20 and/or a mobile pylon 21 that enhances advanced driver assistance systems to enable a safer and more predictable riding experience for vehicles 30 traveling over roadway 19. The MARS maps the surrounding area and vehicles that move in and around the pylon(s) 20, 21. While a single vehicle 30 may be able to track vehicles in visible proximity the linked network of pylons communicate with each other and can provide an enhanced overview of all vehicles and road conditions that a driver may experience in their route of travel. MARS addresses many of the current problems; traffic flow, road hazards, emergency response times, object/trash clean up, potholes 18 and other road surface issues, wrong-way driving, and the unpredictable inconsistency of self-driving vehicles of today. By combining the pylons 20, 21 with their roadside sensors with artificial intelligence and machine learning, MARS gives end-users real-time, precise road data which allows smart vehicles to navigate the streets and roadways 19 with never-before-seen awareness and accuracy. The meshed aware road system increases the level of trust in self-driving technology which greatly increases the adoption rate of self-driving vehicles, speeding us to a highly efficient road 19 system.

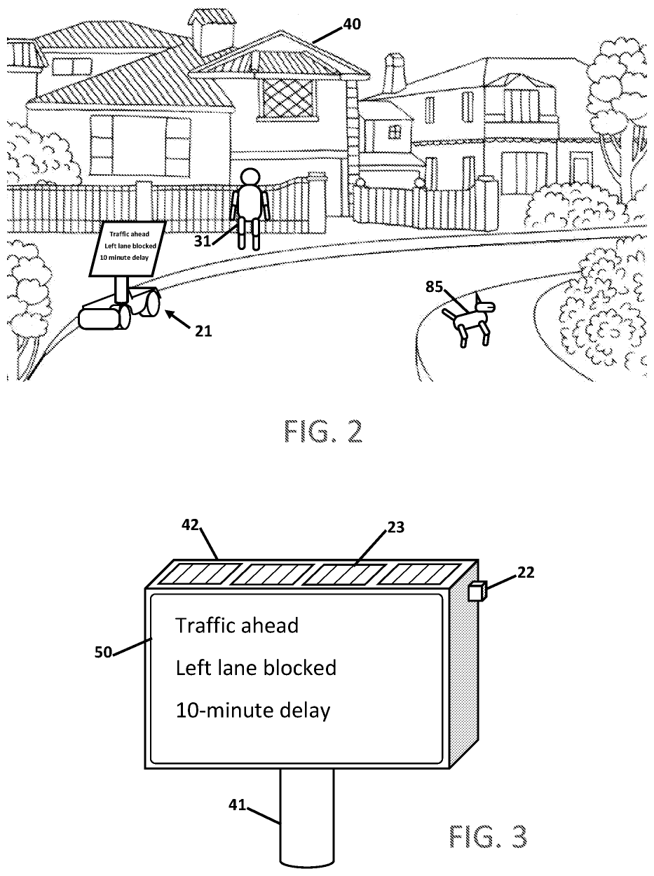

FIG. 2 shows a Mobile Advanced Personal Security (MAPS) pylon 21 that can be installed and activated to protect an individual as they leave their home 40. MARS has many uses to improve the safety and effectiveness of our road systems. MAPS is a non-GPS geo-fencing technology that oversees and monitors the safety of an individual 31 which can only be achieved with the use of road sentinel AI pylon's infrastructure. MAPS takes the interaction of different objects and determines if an emergency event has occurred. As an example, a person 31 may fall and not get up after a period of time. Then activates an appropriate method of remediation for that event. MAPS do not rely upon facial recognition to determine the identity of a person or individual but tracks the interaction of objects. Since the MAPS monitors over a period of time the MAPS can track an object such as a person 31 leaving the home 40.

In an emergency, MAPS can backtrack the individual 31 that has fallen back to the home 40 they left. THE GPS location of the home 40 can be used with phone records to determine the best possible phone number to call for the emergency. This is also applicable to tracking objects such as a pet or dog 32 as they wander and can backtrack to the house when the animal was first detected leaving a location. MAPS can also notify, with a safe zone around a person, or provide advance notice to a person 31 that a loose animal 32 is detected in their proximity. This can also apply to wild animals such as, but not limited to coyotes, bears, bobcats etc.

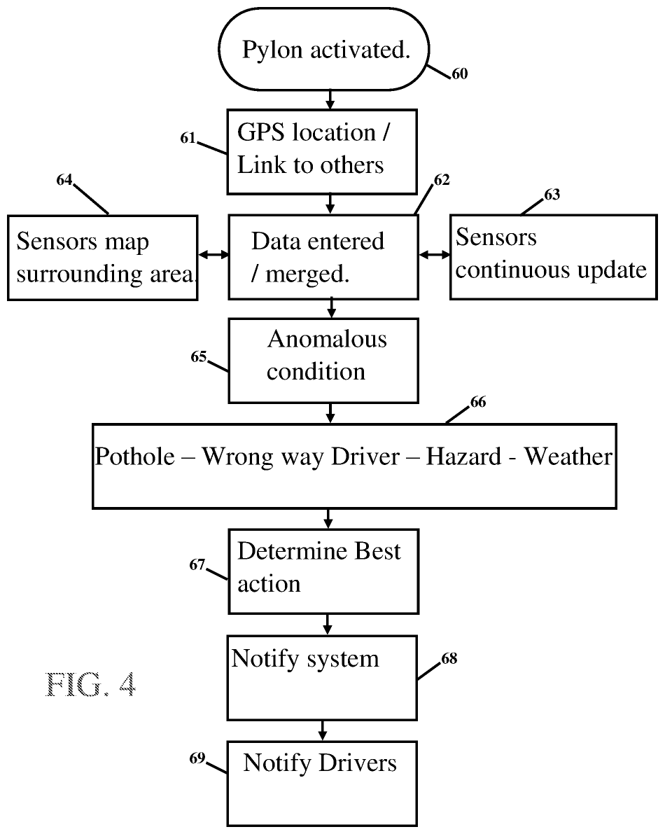

FIG. 3 shows a Traffic Flow Management System (TFMS). RoadSentinelAI will aid in the transition to a fully self-driving future by enhancing the cars of today. A Traffic Flow Management System (TFMS) will control traffic when there is an emergency and divert cars to a specific lane by notifying users and/or with an LED light indicator or digital display monochrome or color sign 50 which can be seen from the pylon(s) 20/21 that can tell a pedestrian or driver where to move. The TFMS can include lights that point to the ground and a road sign to showcase hazard information. TFMS can also create paths for emergency vehicles in congested roadways, improving medical response times.

In this embodiment the sign head and pylon 42 is mounted to a post 41 that can either be on a mobile base or mounted into the ground. There are solar panels 23 that can charge internal batteries. Sensors 22 are mounted internally or on one or more sides. The sensor(s) include, but are not limited to a camera, an infrared detector, thermal imaging, a night vision camera, a lidar, a microphone, a radar, or sonar.

A Hazard Detection and Monitoring System (HDMS) that utilizes artificial intelligence to monitor objects on the road in real-time. HDMS utilizes machine learning and personnel to quickly detect and classify objects which will be shared throughout the roadside sensor infrastructure so that MARS can generate the safest path around objects or hazards like the pothole 18 so the vehicle 30 can change lanes is advance as shown in FIG. 1. The sensors can monitor the roadway for changes such as development of a pothole as it grows, a pedestrian on the road, item(s) that have fallen from a vehicle or a vehicle stopped on the side of a road for an extended period of time.

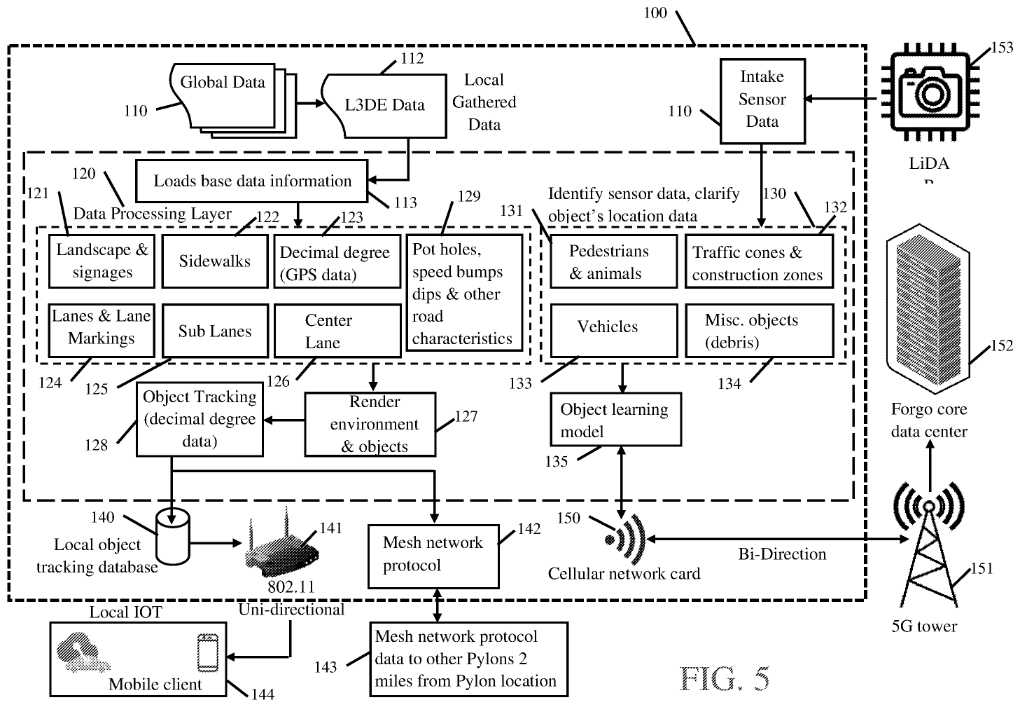

FIG. 4 shows a flow chart of Wrong Way Driver Detection (WAVE) that detects contraflow driving vehicles. Detection uses the base MARS technology that allows for the accurate positioning of vehicles on the road. The road sentinel AI pylon utilizes an algorithm to map out the road.

From FIG. 4 a Grid Road extraction and Detection (GRID) is used. When the pylons are activated and linked, they will start the GRID process and map out the section of the road, and over time to develop a baseline of the road features.

When the pylon is activated 60 it will first identify its location using GPS and a compass to determine orientation it will also link 61 with other pylons or systems. The specific location and data are merged 62 with any other pylons or system. Sensors will map the surrounding area 64 and the sensors will continuously update 63 as vehicles, people and objects move around the pylon. An anomalous condition 65, such as the previously indicated wrong-way driver, pothole, hazard, or weather will make the system determine the best action 67. A notification system 68 will send indicators to other pylons and local drivers 69. The pylon can illuminate lights that point to the ground and a road sign to showcase hazard information. In the case of a wrong way driver the sign can briefly flash to the wrong way driver to turn around while the wrong way driver is in the closest proximity to the pylon. The sign can detect and notify drivers when a red light will turn green or provide advance notice with a light will be turning yellow or red so the driver can better judge how to handle the intersection for smoother traffic flow.

The preferred embodiment further includes an Individual Non-RESPonsiveness (INORESP) that helps individuals like the elderly when they fall and are not responsive as described with FIG. 2. A preliminary call can be made causing an alert that can try to wake the elderly. Then a call can be made to a caregiver or a family member. If these actions fail, then a call to the medical response unit like an ambulance could be activated. This is useful for an outdoor enthusiast or exerciser that wants to be overwatched during their excursion.

Since the system observes objects over an extended period time like days, weeks, months, and years it can observe that an object leaves a specific home every morning for a walk and if the object does not repeat the pattern, it can initiate a safety, wellness, or health check. This also applies to mail and recurring deliveries such as food, gardener, pool service and mail service. For anonymity purposes the pylon and system use a one-foot by one-foot square data block to identify objects and can re-create the surrounding environment in a 3-D virtual environment that can be viewed in real time or rebuilt from historical data. The one-foot by one-foot square data block is sufficient to track most objects and approximate the type of object such as a person, animal, pothole, or vehicle based upon general size. Tracking movement of the object from a particular location such as a house or vehicle provides the historical record. In the future the owner of a vehicle or person can identify the location of a vehicle or home at a specific time/date to determine the route to locate a missing person, animal or stolen vehicle.

Also as shown and described in FIG. 2 the system has a Finding Individuals with Dementia or Lost (FIDL) function that follows objects that wonder and determine their starting point and current location to quickly find individuals. FIDL can also be used to track pets when they roam around the neighborhood. If an individual or a pet goes beyond the set location a notification can be sent to caregivers or pet owners.

FIG. 5 shows a block diagram of a pylon 100 with the internal and external communication connections. Each Pylon 100 has their own internal sensor array, data storage and communication where the Pylon 100 can sense objects around the Pylon 100 and can communicate with other pylons and networks. The Pylon 100 has global data 110 for general information and knowledge about the prediction of objects and traffic, as well as L3DE data 112 that relates to local data such as objects and traffic that are in proximity to the pylon. The knowledgebase is loaded 113 into each Pylon 100 and goes into a data processing layer 120.

Within the data processing layer 120 the pylon 100 is loaded with information related to landscape & signage 121, sidewalks 122, decimal degree Global Positioning System (GPS) data 123 for a pixelized 360-degree view of the surrounding area, lanes & lane markings 124, sub lanes 125 and center lanes 126 for the streets. Other landscape anomalies can be added to the database, such as, but not including pot holes, speed bumps, dips and other road characteristics 129. The pylon 100 will render the environment and object 127 to create a flat point cloud 3D rendered point cloud virtual environment or a baseline to determine and track the movement of objects and the decimal degree of movement 128 within the environment.

A variety of sensors are located within and around the pylon 100 and the pylon 100 can be loaded with LiDAR 152 and other sensor intake data 110 information to create the virtual topographical environment surrounding each pylon 100. The sensors identify and clarify the movement of objects location data 130. This data includes, but is not limited to, pedestrians & animals 131, traffic cones & construction zones 132, vehicles 133 and miscellaneous objects such as debris 134. All of this information provides an object learning model 135 that is communicated over a cellular (or other) network 150.

The object tracking 128 is both stored in a local object tracking database 140 and is communicated using a modem 141 (or similar device) to mobile client 144 and over a Mesh (or similar) network protocol 142 as a mobile client 144 that communicates with Mesh (or similar) network protocol data to other pylons 2 or more (or less) miles from the pylon 100 location 143. There is also bi-directional communication with the cellular network card 150 (or similar device) using 5G (or similar) communication tower(s) 151 into a Forgo Core Data Center 152 (or similar).

Thus, specific embodiments of a road sentinel AI pylon have been disclosed. It should be apparent, however, to those skilled in the art that many more modifications besides those described are possible without departing from the inventive concepts herein. The inventive subject matter, therefore, is not to be restricted except in the spirit of the appended claims.

1. A road sentinel AI pylon comprising:
a pylon having at least one sensor;
said at least one sensor is configured to locate a fixed object and locate and track a moving or changing object;
said pylon further including a wireless communication system and
said pylon further includes a notification that provides information to a driver or an authority.

2. The road sentinel AI pylon according to claim 1, wherein said notification is a text message, an email, a changeable sign, an LED light or a light.

3. The road sentinel AI pylon according to claim 1, wherein sensor is selected from the group consisting of a camera, an infrared detector, thermal imaging, a night vision camera, a LiDAR, a microphone, a radar, and a sonar.

4. The road sentinel AI pylon according to claim 1, wherein sensor maps movement of an object as an anonymous data block.

5. The road sentinel AI pylon according to claim 1, wherein said pylon is pre-loaded with topographical baseline data that creates a 3-D rendered environment around said pylon.

6. The road sentinel AI pylon according to claim 5, wherein said 3-D environment is created as a decimal degree data.

7. The road sentinel AI pylon according to claim 5, wherein said 3-D environment includes at least two of landscape, signage, sidewalks, lanes, lane markings, center lane, sub lanes, pot holes, speed bumps, and dips.

8. The road sentinel AI pylon according to claim 1, wherein said at least one sensor tracks a group consisting of pedestrians, animals, vehicles, traffic cones, construction zones, and debris.

9. The road sentinel AI pylon according to claim 8, wherein said pylon uses data from said at least one sensor to create an object learning model.

10. The road sentinel AI pylon according to claim 9, wherein said object learning model is used to create a historical model of changes in location of said pedestrians, animals, vehicles, traffic cones, construction zones, and debris.

11. The road sentinel AI pylon according to claim 1, wherein said object learning model is communicated over said wireless communication system to a core data center.

12. The road sentinel AI pylon according to claim 5, wherein said 3-D environment is stored on a local object tracking database.

13. The road sentinel AI pylon according to claim 12, wherein said 3-D environment is communicated to a mobile client.

14. The road sentinel AI pylon according to claim 13, wherein said mobile client receives real-time information regarding said fixed object and said moving and said changing object around said road sentinel AI pylon.

15. The road sentinel AI pylon according to claim 5, wherein said 3-D environment is communicated over a Mesh network protocol.

16. The road sentinel AI pylon according to claim 14, wherein said moving and said changing object around said road sentinel AI pylon is an individual, an animal or a contraflow driving vehicle(s).

17. The road sentinel AI pylon according to claim 1, wherein said road sentinel AI pylon uses historical information to project future movement of a vehicle, individual or an animal.

18. The road sentinel AI pylon according to claim 1, wherein said road sentinel AI pylon is battery and solar powered.

19. The road sentinel AI pylon according to claim 1, wherein said road sentinel AI pylon uses non-GPS geo-fencing technology that oversees and monitors safety of an individual and extrapolates GPS location of objects within the environment.

20. The road sentinel AI pylon according to claim 1, further includes at least a second road sentinel AI pylon that communicates over said wireless communication system to said road sentinel AI pylon.
